(19) United States
(12) Patent Application Publication
(10) Pub. No.: US 2004/0224866 A1
(43) Pub. Date: Nov. 11, 2004

(54) Cleaning solution and cleaning process using the solution

(76) Inventors: Hiroshi Matsunaga, Tokyo (JP); Masaru Ohto, Tokyo (JP); Kenji Yamada, Tokyo (JP); Hidetaka Shimizu, Tokyo (JP); Ken Tsugane, Tokyo (JP); Seiki Oguni, Tokyo (JP); Yoshiya Kimura, Ibaraki-ken (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/777,085

(22) Filed: Feb. 13, 2004

(30) Foreign Application Priority Data
Feb. 19, 2003 (JP) 40930/2003
Nov. 12, 2003 (JP) 382738/2003

(51) Int. Cl. C11D 1/00

(52) U.S. Cl. 510/175

(57) ABSTRACT

(1) A cleaning solution for semiconductor substrates comprising an oxidizing agent, an acid and a fluorine compound, having a pH adjusted in the range of 3 to 10 by addition of a basic compound and having a concentration of water of 80% by weight or greater, (2) a cleaning solution for semiconductor substrates comprising an oxidizing agent, an acid, a fluorine compound and a corrosion inhibitor, having a pH adjusted in the range of 3 to 10 by addition of a basic compound and having a concentration of water of 80% by weight or greater, and a process for cleaning semiconductor substrates having metal wiring which comprises cleaning with the cleaning solution, are provided. The cleaning solution can completely remove residues of etching on semiconductor substrates in a short time, does not corrode copper wiring materials and insulation film materials, is safe and exhibits little adverse effects on the environment.

### TECHNICAL FIELD

The present invention relates to a cleaning solution for removing substances attached to the surface of semiconductor substrates and a process for cleaning using the solution. More particularly, the present invention relates to a cleaning solution which can remove substances strongly attached to the surface of semiconductor substrates without damaging metal wiring and interlayer insulation films on the semiconductor substrates and a cleaning process using the solution.

### BACKGROUND ART

At present, in general, the lithography is used as the process for producing semiconductor devices such as the highly integrated LSI. When a semiconductor device is produced in accordance with the lithography, in general, the process for the production is conducted in accordance with the following series of steps. Electrically conductive thin films such as metal films used as the electrically conductive material for wiring and interlayer insulation films such as silicon oxide films used for insulation between electrically conductive thin films and wiring are formed on a substrate such as a silicon wafer. Then, the surface of the obtained substrate is uniformly coated with a photoresist to form a light-sensitive layer, and a desired pattern is formed on the photoresist by the selective exposure to light and the developing treatment. Using the formed resist pattern as the mask, the thin film below the resist layer is selectively etched, and the desired pattern is formed on the thin film below the resist layer through the resist pattern. Thereafter, the resist pattern is completely removed.

Recently, semiconductors are highly integrated, and the formation of a pattern of 0.18 μm or smaller is required. As the dimension of the working becomes finer, the dry etching is becoming the main process used for the selective etching treatment. In the dry etching treatment, it is known that residues derived from the dry etching gas, the resist, the film for working and materials in the chamber of the dry etching apparatus (hereinafter, these residues will be referred to as the etching residues) are formed at portions in the periphery of the pattern formed by the treatment. When the etching residues remain at portions inside and in the periphery of via holes, there is the possibility that undesirable phenomena such as an increase in the resistance and electric short circuit arise.

Heretofore, as the cleaning solution for removing etching residues in the step of forming metal wiring in semiconductor devices, for example, organic amine-based removing solutions composed of a mixed system of an alkanolamine and an organic solvent are disclosed in Japanese Patent Application Laid-Open Nos. Showa 62(1987)-49355 and Showa 64(1989)-42653.

When the organic amine-based removal solution is used, dissociation of the amine in the removal solution takes place due to the moisture absorbed in washing with water after the removal of the etching residues and the resist. The solution becomes alkaline and, as the result, there is the possibility that metals of thin films used as the materials for fine working of wiring are corroded. This causes a problem in that an organic solvent such as an alcohol must be used as the rinsing liquid to prevent the corrosion.

As the cleaning solution exhibiting more excellent ability of removing etching residues and cured layers of the resist than that of the organic amine-based removing solution, fluorine-based cleaning solutions composed of a fluorine compound, an organic solvent and a corrosion inhibitor are disclosed in Japanese Patent Application Laid-Open Nos. Heisei 7(1995)-201794 and Heisei 11(1999)-67632. However, due to recent severer conditions of the dry etching in the process for producing semiconductor devices, the resist itself tends to be degraded with the gases used for the dry etching at the temperature of the dry etching, and the complete removal of the etching residues with the above organic amine-based removing solutions or the above fluorine-based aqueous solutions is becoming difficult.

It is becoming difficult due to the great electric resistance that a circuit made of materials containing aluminum as the main component, which have heretofore been used frequently as the wiring material, works properly at a high speed, and the utilization of copper alone as the wiring material is increasing. Therefore, it is important for producing semiconductor devices having an excellent quality that the etching residues are efficiently removed without damaging the wiring material.

The organic amine-based cleaning solution and the fluorine-based cleaning solution, which contain great amounts of organic solvents, cause a problem in that great effort on the environment such as assurance of safety and treatments of waste fluids is required, and the means for overcoming the problem is becoming important. For example, an acid-based cleaning agent which is an aqueous solution of an organic acid is disclosed in Japanese Patent Application Laid-Open No. Heisei 10(1998)-72594, and an acid-based cleaning agent which is an aqueous solution of nitric acid, sulfuric acid and phosphoric acid is disclosed in Japanese Patent Application Laid-Open No. 2000-338686. However, these cleaning agents exhibit insufficient ability to remove etching residues which have become stronger and, in particular, etching residues containing the components of the interlayer insulation films.

Therefore, in the process for producing semiconductor devices, a cleaning solution which can completely remove the etching residues without damaging the wiring materials, provides safety in the process for producing semiconductor devices and exhibits little adverse effects on the environment has been desired.

The present invention has an object of providing a cleaning solution which can remove etching residues remaining after the dry etching in the step of wiring semiconductor devices or display devices which are used for semiconductor integrated circuits or after the dry etching of semiconductor substrate in a short time without oxidizing or corroding materials of copper wiring and insulation films and a process for cleaning semiconductor devices, display devices and semiconductor substrates having metal wiring using the cleaning solution.

### DISCLOSURE OF THE INVENTION

As the result of intensive studies by the present inventors to overcome the above problems, it was found that an excellent cleaning solution could be obtained by the combined use of an oxidizing agent, an acid, a fluorine compound, a basic compound and a corrosion inhibitor.

The present invention provides:

(1) A cleaning solution for semiconductor substrates, which comprises an oxidizing agent, an acid and a fluorine compound, has a pH adjusted in a range of 3 to 10 by addition of a basic compound and has a concentration of water of 80% by weight or greater;

(2) A cleaning solution for semiconductor substrates, which comprises an oxidizing agent, an acid, a fluorine compound and a corrosion inhibitor, has a pH adjusted in a range of 3 to 10 by addition of a basic compound and has a concentration of water of 80% by weight or greater; and

(3) A process for cleaning semiconductor substrates having metal wiring, which comprises cleaning with a cleaning solution described above in any one of (1) and (2).

### BRIEF DESCRIPTION OF THE DRAWINGS

FIG. 1 shows a diagram exhibiting a portion of the section of a semiconductor device which was obtained by forming a film of silicon nitride and a film of silicon oxide by deposition on copper wiring at a lower layer, followed by the treatment by etching and the removal of the residual resist.

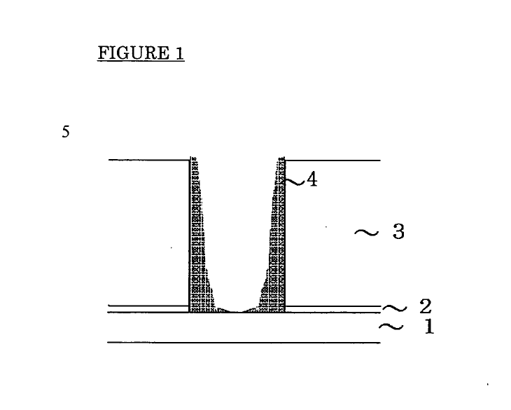

Numbers in FIG. 1 has the following meanings:

1: Copper wiring at the lower layer

2: A film of silicon nitride

3: A film of silicon oxide

4: Etching residues

### THE MOST PREFERRED EMBODIMENT TO CARRY OUT THE INVENTION

Examples of the oxidizing agent used in the cleaning solution of the present invention include iodine, periodic acid, iodic acid, hydrogen peroxide, nitric acid and nitrous acid. Among these oxidizing agents, hydrogen peroxide and nitric acid are preferable, and nitric acid is more preferable. The above oxidizing agent may be used singly or in combination of two or more in the present invention. It is preferable that the concentration of the oxidizing agent in the cleaning solution of the present invention is in the range of 0.001 to 10% by weight and more preferably in the range of 0.005 to 8% by weight.

Examples of the acid used in the cleaning solution of the present invention include inorganic acids and organic acids. Examples of the inorganic acid include boric acid, sulfamic acid, phosphoric acid, hypophosphorous acid, carbonic acid, hydrochloric acid and sulfuric acid. Among these acids, boric acid, sulfamic acid, phosphoric acid, carbonic acid and sulfuric acid are preferable, and sulfuric acid is more preferable. Examples of the organic acid include oxalic acid, citric acid, propionic acid, acetic acid, malonic acid, maleic acid, glycolic acid, diglycolic acid, tartaric acid, itaconic acid, pyruvic acid, malic acid, adipic acid, formic acid, succinic acid, phthalic acid, benzoic acid, salicylic acid, carbamic acid, thiocyanic acid and lactic acid. Among these acids, oxalic acid, citric acid, propionic acid and acetic acid are preferable. The above acid may be used singly or in combination of two or more in the present invention. It is preferable that the concentration of the acid in the cleaning solution of the present invention is in the range of 0.001 to 10% by weight and more preferably in the range of 0.005 to 8% by weight. The concentrations of the oxidizing agent and the acid may be the same with or different from each other. It is preferable that the ratio of the amount by weight of the acid to the amount by weight of the oxidizing agent is in the range of 0.1 to 1,000, more preferably in the range of 1.0 to 100 and most preferably in the range of 1 to 60.

The concentration of water in the cleaning solution is 80% or greater and preferably 85% or greater.

By adjusting the concentrations of the oxidizing agent, the acid and water in the above ranges, the etching residues can be efficiently removed, and corrosion of wiring materials can be effectively suppressed.

Examples of the fluorine compound used in the present invention include hydrofluoric acid, ammonium fluoride, acidic ammonium fluoride and quaternary ammonium fluoride represented by the following general formula (1):

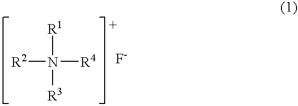

wherein R¹, R², R³ and R⁴ each independently represent an alkyl group, a hydroxyalkyl group, an alkoxyalkyl group or an alkenyl group each having 1 to 6 carbon atoms or an aryl group or an aralkyl group each having 6 to 12 carbon atoms.

Examples of the quaternary ammonium fluoride represented by general formula (1) include tetramethylammonium fluoride, tetraethylammonium fluoride, triethylmethylammonium fluoride, trimethylhydroxyethylammonium fluoride, tetraethanolammonium fluoride and methyltriethanolammonium fluoride. Among these compounds, ammonium fluoride and tetramethylammonium fluoride are preferable.

The above fluorine compounds may be used singly or in combination of two or more in the present invention. The concentration of the fluorine compound in the cleaning solution of the present invention is preferably in the range of 0.001 to 15% by weight and more preferably in the range of 0.005 to 10% by weight. When the concentration of the fluorine compound is 0.001% by weight or greater, the etching residues can be efficiently removed. When the concentration of the fluorine compound exceeds 15% by weight, there is the possibility that corrosion of wiring materials takes place.

The corrosion inhibitor used in the present invention is not particularly limited. Corrosion inhibitors derived from various compounds such as phosphoric acid, carboxylic acids, amines, oximes, aromatic hydroxyl compounds, triazole compounds and sugar-alcohols can be used. Preferable examples of the corrosion inhibitor include polyethyleneimines having at least one amino group or thiol group in the molecule, triazoles such as 3-aminotriazole, triazine derivatives such as 2,4-diamino-6-methyl-1,3,5-triazine, pterin derivatives such as 2-amino-4-hydroxypterin and 2-amino-4,6-dihydroxypterin, and polyaminesulfone. Among these compounds, polyethyleneimines (PEI) expressed by the following formulae (2):

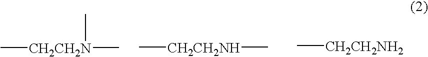

and having an average molecular weight in the range of 200 to 100,000 and more preferably in the range of 1,000 to 80,000 are preferable.

As the basic compound used in the present invention, bases having no metal ions are preferable. Examples of the basic compound include ammonia, primary amines, secondary amines, tertiary amines, imines, alkanolamines, heterocyclic compounds which have nitrogen atom and may have alkyl groups having 1 to 8 carbon atoms and quaternary ammonium hydroxides represented by the following general formula (3):

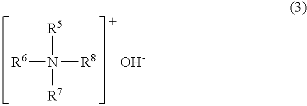

wherein R⁵, R⁶, R⁷ and R⁸ each independently represent an alkyl group, a hydroxyalkyl group, an alkoxyalkyl group or an alkenyl group each having 1 to 6 carbon atoms or an aryl group or an aralkyl group each having 6 to 12 carbon atoms.

Examples of the primary amine include ethylamine, n-propylamine, butylamine, 1-ethylbutylamine, 1,3-diaminopropane and cyclohexylamine.

Examples of the secondary amine include diethylamine, di-n-propylamine, di-n-butylamine and 4,4′-diaminodiphenylamine.

Examples of the tertiary amine include dimethylethylamine, diethylmethylamine, triethylamine and tributylamine.

Examples of the imine include 1-propaneimine and bis(dialkylamino)imines.

Examples of the alkanolamine include monoethanolamine, diethanolamine, triethanolamine, diethylethanolamine and propanolamine.

Examples of the heterocyclic compound which has nitrogen atom and may have alkyl groups having 1 to 8 carbon atoms include pyrrol, imidazole, pyrazole, pyridine, pyrrolidine, 2-pyrroline, imidazolidine, 2-pyrazoline, pyrazolidine, piperidine, piperadine and morpholine.

Examples of the quaternary ammonium hydroxide represented by general formula (3) include tetramethylammonium hydroxide (TMAH), trimethylhydroxyethylammnoium hydroxide (choline), methyl-trihydroxyethylammonium hydroxide, dimethyldihydroxyethylammonium hydroxide, trimethylethylammonium hydroxide, tetraethylammonium hydroxide, tetrabutylammonium hydroxide and tetraethanolammonium hydroxide. Among these basic compounds, tetramethylammonium hydroxide and trimethylhydroxyethylammonium hydroxide (choline), which are strong bases, are preferable.

The above basic compounds used in the present invention may be used singly or in combination of two or more. The basic compound is, in general, used in a concentration in the range of 0.01 to 15% by weight in the cleaning solution. The concentration can be suitably decided so that pH of the cleaning solution is adjusted in the range of 3 to 10.

In the cleaning solution of the present invention, a surfactant may be added and used to improve the wetting property. As the surfactant, any surfactants including cationic surfactants, anionic surfactants, nonionic surfactants and fluorine-contained surfactants can be used. Among these surfactants, anionic surfactants are preferable, and phosphoric esters of polyoxy-ethylenealkyl ethers and phosphoric esters of polyoxyethylenealkyl aryl ethers are more preferable. As the phosphoric ester of a polyoxyethylenealkyl ether, for example, PLYSURF A215C (a trade name) manufactured by DAIICHI KOGYO SEIYAKU Co., Ltd. and PHOSPHANOL RS-710 (a trade name) manufactured by TOHO Chemical Industry Co., Ltd. are commercially available. As the phosphoric ester of a polyoxyethylenealkyl aryl ether, for example, PLYSURF A212E and A217E (trade names) manufactured by DAIICHI KOGYO SEIYAKU Co., Ltd. are commercially available.

The surfactant may be used singly or in combination of two or more in the present invention. The concentration of the surfactant in the cleaning solution is preferably in the range of 0.0001 to 5% by weight and more preferably in the range of 0.001 to 0.1% by weight.

The cleaning solution of the present invention may comprise other additives conventionally used for cleaning solutions as long as the object of the present invention is not adversely affected. pH of the cleaning solution of the present invention is in the range of 3 to 10, preferably in the range of 3 to 7 and more preferably in the range of 4 to 6. When pH of the cleaning solution is in the range of 3 to 10, the etching residues can be efficiently removed, and pH can be suitably selected in this range in accordance with the conditions of the etching and the used semiconductor substrate.

Temperature for the cleaning process of the present invention is generally in the range of room temperature to 90° C., and temperature can be suitably selected in this range in accordance with the conditions of the etching and the used semiconductor substrate.

Examples of the semiconductor substrate to which the cleaning solution of the present invention is applied include semiconductor substrates having metal wiring materials such as silicon, amorphous silicon, polysilicon, silicon oxide films, silicon nitride films, copper, titanium, titanium-tungsten, titanium nitride, tungsten, tantalum, tantalum compounds, chromium, chromium oxides and chromium alloys; semiconductor substrates having compound semiconductors such as gallium-arsenic, gallium-phosphorus and indium-phosphorus; printed substrates such as printed substrates of polyimide resin; and glass substrates used for LCD.

The cleaning solution of the present invention can be effectively used for, among the above semiconductor substrates, semiconductor substrates having metal wiring of copper alone or a laminate structure of copper and a barrier metal (an interface metal layer) so that the circuit in a semiconductor device or a display device having metal wiring can work at a great speed.

The cleaning process of the present invention may be conducted in combination with the ultrasonic cleaning, where necessary. For the rinsing after the etching residues on the semiconductor device, the display device or the semiconductor substrate having metal wiring have been removed, an organic solvent such as an alcohol or a mixture of an alcohol and ultra-pure water may be used. However, in accordance with the cleaning process of the present invention, the rinsing with ultra-pure water alone is sufficient.

### EXAMPLES

The present invention will be described more specifically with reference to Examples and Comparative Examples in the following. However, the present invention is not limited to the examples.

### Examples 1 to 17 and Comparative Examples 1 to 14

FIG. 1 shows a diagram exhibiting a portion of the section of a semiconductor device. The semiconductor device was obtained as follows: a silicon nitride film 2 and a silicon oxide film 3 were successively formed by deposition on copper wiring 1 at the lower layer in accordance with the CVD process; the formed laminate was coated with a resist; the resist was worked in accordance with the conventional photo-technology; the silicon oxide film was etched to have a desired pattern using the dry etching technology; and the residual resist was removed. As shown in FIG. 1, etching residues were left remaining on the walls formed by the etching.

The above copper circuit device was cleaned with cleaning solutions shown in Table 1 to 8 under the conditions shown in the tables, rinsed with ultra-pure water and dried. Thereafter, the condition of the surface was observed using a scanning electron microscope (SEM), and the conditions of the removal of the etching residues and the corrosion of the copper wiring were evaluated. The results of the evaluation are shown in Tables 1 to 4 and in Tables 5 to 8.

The criteria for the evaluation are shown in the following.

(1) Removal of Etching Residues

excellent: The etching residues were completely removed.

good: The etching residues were almost completely removed.

fair: A portion of the etching residues remained.

poor: Most of the etching residues remained.

(2) Corrosion of Copper

excellent: No corrosion was found at all.

good: Almost no corrosion was found.

fair: Corrosion of a crater shape or a pit shape was found.

poor: “Roughening” was found on the entire surface of the copper layer, and thinning of the copper layer was found.

TABLE 1

| | Example | | | |
|---|---|---|---|---|
| | 1 | 2 | 3 | 4 |
| Composition of | | | | |
| cleaning solution | | | | |
| (% by weight) | | | | |
| nitric acid (oxidizing | 0.6 | 0.1 | 2.0 | 0.3 |
| agent) | | | | |
| sulfuric acid (acid) | 3.0 | 4.0 | 3.0 | 3.0 |
| ratio of amounts | 5 | 40 | 1.5 | 10 |
| by weight:acid/ | | | | |
| oxidizing agent | | | | |
| ammonium fluoride | 0.3 | — | — | — |
| tetramethylammonium | — | 0.5 | 0.3 | 0.4 |
| fluoride | | | | |
| tetramethylammonium | 6.3 | 7.5 | 8.4 | 5.8 |
| hydroxide | | | | |
| water | 89.8 | 87.9 | 86.3 | 90.5 |
| pH | 4 | 5 | 4 | 5 |
| Condition of cleaning | | | | |
| temperature (° C.) | 40 | 40 | 40 | 70 |
| time (minute) | 3 | 3 | 3 | 1.5 |
| Removal of etching | excellent | excellent | excellent | excellent |
| residues | | | | |
| Corrosion of copper | excellent | excellent | excellent | excellent |

TABLE 2

| | Example | | | | |
|---|---|---|---|---|---|
| | 5 | 6 | 7 | 8 | 9 |
| Composition of cleaning solution | | | | | |
| (% by weight) | | | | | |
| hydrogen peroxide (oxidizing | — | — | — | 2.0 | 10.0 |
| agent) | | | | | |
| nitric acid (oxidizing agent) | 0.6 | 0.2 | 0.2 | — | — |
| sulfuric acid (acid) | 2.0 | 4.0 | 4.0 | — | — |
| boric acid (acid) | — | — | — | 1.0 | — |
| propionic acid (acid) | — | — | — | 1.0 | — |
| acetic acid (acid) | — | — | — | — | 2.0 |
| ratio of amounts by weight:acid/ | 3.3 | 20 | 20 | 1.0 | 0.2 |
| oxidizing agent | | | | | |
| ammonium fluoride | — | 0.5 | — | — | — |
| tetramethylammonium | 3.0 | — | 1.0 | 9.0 | 1.5 |
| fluoride | | | | | |
| tetramethylammonium | 4.6 | — | 7.3 | — | 2.1 |
| hydroxide | | | | | |
| choline | — | 7.5 | — | 1.2 | — |
| surfactant* | — | — | 0.5 | — | — |
| water | 89.8 | 87.8 | 87.0 | 85.8 | 84.4 |
| pH | 6 | 4 | 4 | 8 | 5 |
| Condition of cleaning | | | | | |
| temperature (° C.) | 40 | 40 | 40 | 60 | 50 |
| time (minute) | 3 | 3 | 2 | 2 | 3 |
| Removal of etching residues | excellent | excellent | excellent | excellent | excellent |
| Corrosion of copper | excellent | excellent | excellent | excellent | excellent |

*Surfactant: manufactured by TOHO Chemical Industry Co., Ltd.; the trade name: PHOSPHANOL RS-710

TABLE 3

| | Comparative Example | | | | |
|---|---|---|---|---|---|
| | 1 | 2 | 3 | 4 | 5 |
| Composition of cleaning solution | | | | | |
| (% by weight) | | | | | |
| nitric acid (oxidizing agent) | — | 6.0 | 0.2 | 0.3 | 0.2 |
| sulfuric acid (acid) | 3.0 | 0.1 | 4.0 | 3.0 | 4.0 |
| ratio of amounts by weight:acid/ | — | 0.02 | 20 | 10 | 20 |
| oxidizing agent | | | | | |
| ammonium fluoride | 0.7 | — | — | 0.2 | 0.2 |
| tetramethylammonium | — | 0.3 | — | — | — |
| fluoride | | | | | |
| tetramethylammonium | 5.5 | 8.5 | 7.6 | — | 10.5 |
| hydroxide | | | | | |
| water | 90.8 | 85.1 | 88.2 | 96.5 | 85.1 |
| pH | 5 | 4 | 4 | 1 | 11 |
| Condition of cleaning | | | | | |
| temperature (° C.) | 40 | 40 | 50 | 40 | 40 |
| time (minute) | 3 | 3 | 3 | 3 | 3 |
| Removal of etching residues | fair | fair | fair | excellent | poor |
| Corrosion of copper | excellent | excellent | excellent | poor | excellent |

TABLE 4

Comparative
Example

| | 6 | 7 |
|---|---|---|
| Composition of cleaning solution | | |
| (% by weight) | | |
| hydrogen peroxide (oxidizing agent) | 5.0 | — |
| sulfamic acid (acid) | — | 1.5 |
| boric acid (acid) | — | 2.0 |
| ratio of amounts by | — | — |
| weight:acid/ | | |
| oxidizing agent | | |
| tetramethylammonium fluoride | 2.5 | 0.3 |
| tetramethylammonium hydroxide | 0.9 | 2.1 |
| water | 91.6 | 94.1 |
| pH | 7 | 8 |
| Condition of cleaning | | |
| temperature (° C.) | 40 | 40 |
| time (minute) | 5 | 3 |
| Removal of etching residues | fair | fair |
| Corrosion of copper | excellent | excellent |

As shown in Tables 1 and 2, in Examples 1 to 9 in which the cleaning solution and the cleaning process of the present invention were applied, no corrosion was found at all, and the removal of the etching residues was complete. In all of Comparative Examples 1 to 7, as shown in Tables 3 and 4, the removal of the etching residues was incomplete or the corrosion of copper was found.

TABLE 5

| | Example | | | |
|---|---|---|---|---|
| | 10 | 11 | 12 | 13 |
| Composition of | | | | |
| cleaning solution | | | | |
| (% by weight) | | | | |
| nitric acid (oxidizing | 0.5 | 0.1 | 0.1 | 2.0 |
| agent) | | | | |
| sulfuric acid (acid) | 3.5 | 4.0 | 4.0 | 2.0 |
| ratio of amounts by | 7 | 40 | 40 | 1.0 |
| weight:acid/ | | | | |
| oxidizing agent | | | | |
| ammonium fluoride | 0.5 | — | — | — |
| tetramethylammonium | — | 0.5 | 0.5 | 0.7 |
| fluoride | | | | |
| tetramethylammonium | 6.2 | 7.5 | 7.5 | 3.0 |
| hydroxide | | | | |
| polyethyleneimine* | 0.5 | 0.01 | 0.01 | 2.0 |
| water | 88.8 | 87.89 | 87.89 | 90.3 |
| pH | 5 | 5 | 5 | 4 |
| Condition of cleaning | | | | |
| temperature (° C.) | 40 | 40 | 50 | 50 |
| time (minute) | 3 | 3 | 10 | 3 |
| Removal of etching | excellent | excellent | excellent | excellent |
| residues | | | | |
| Corrosion of copper | excellent | excellent | excellent | excellent |

*Polyethyleneimine having an average molecular weight of 10,000

TABLE 6

| | Example | | | | |
|---|---|---|---|---|---|
| | 14 | 15 | 16 | 17 | 18 |
| Composition of cleaning solution | | | | | |
| (% by weight) | | | | | |
| nitric acid (oxidizing agent) | 0.1 | 0.2 | 0.3 | 1.5 | 1.0 |
| sulfuric acid (acid) | 6.0 | 5.0 | 3.0 | — | — |
| phosphoric acid (acid) | — | — | — | 3.0 | — |
| oxalic acid (acid) | — | — | — | — | 2.5 |
| citric acid (acid) | — | — | — | — | 1.5 |
| ratio of amounts by weight:acid/ | 60 | 25 | 10 | 2 | 4 |
| oxidizing agent | | | | | |
| ammonium fluoride | — | 1.0 | 0.7 | — | 0.5 |
| tetramethylammonium | 3.0 | — | — | 6.0 | — |
| fluoride | | | | | |
| tetramethylammonium | 10.7 | — | 5.1 | 6.1 | 5.9 |
| hydroxide | | | | | |
| choline | — | 9.0 | — | — | — |
| polyethyleneimine* | 0.1 | 0.2 | 0.3 | 0.05 | 1.0 |
| surfactant** | — | — | 0.05 | — | — |
| water | 80.1 | 84.6 | 90.6 | 83.35 | 87.6 |
| pH | 6 | 5 | 4 | 7 | 7 |
| Condition of cleaning | | | | | |
| temperature (° C.) | 60 | 40 | 30 | 70 | 30 |
| time (minute) | 2 | 3 | 4 | 2 | 4 |
| Removal of etching residues | excellent | excellent | excellent | excellent | excellent |
| Corrosion of copper | excellent | excellent | excellent | excellent | excellent |

*Polyethyleneimine having an average molecular weight of 10,000
**Surfactant: manufactured by TOHO Chemical Industry Co., Ltd.; an anionic surfactant; the trade name: PHOSPHANOL RS-710

TABLE 7

| | Comparative Example | | | | |
|---|---|---|---|---|---|
| | 8 | 9 | 10 | 11 | 12 |
| Composition of cleaning solution | | | | | |
| (% by weight) | | | | | |
| nitric acid (oxidizing agent) | — | 0.1 | 2.0 | 1.0 | 0.2 |
| sulfuric acid (acid) | 5.0 | 4.0 | 4.0 | 2.5 | 1.0 |
| ratio of amounts by weight:acid/ | — | 40 | 2 | 2.5 | 5 |
| oxidizing agent | | | | | |
| ammonium fluoride | — | — | — | 0.5 | — |
| tetramethylammonium | 2.0 | 0.5 | — | — | 3.0 |
| fluoride | | | | | |
| tetramethylammonium | 8.9 | 7.5 | 6.7 | — | 2.3 |
| hydroxide | | | | | |
| polyethyleneimine* | 0.01 | — | 2.0 | — | 0.2 |
| water | 84.09 | 87.9 | 88.2 | 96.0 | 87.9 |
| pH | 5 | 5 | 4 | 1 | 12 |
| Condition of cleaning | | | | | |
| temperature (° C.) | 40 | 50 | 70 | 30 | 50 |
| time (minute) | 3 | 10 | 3 | 3 | 3 |
| Removal of etching residues | fair | excellent | fair | excellent | poor |
| Corrosion of copper | excellent | fair | excellent | fair | excellent |

*Polyethyleneimine having an average molecular weight of 1,800

TABLE 8

Comparative
Example

| | 13 | 14 |
|---|---|---|
| Composition of cleaning solution | | |
| (% by weight) | | |
| nitric acid (oxidizing agent) | — | 0.05 |
| citric acid (acid) | 5.0 | 8.0 |
| ratio of amounts by weight:acid/ | — | 160 |
| oxidizing agent | | |
| tetramethylammonium | 2.0 | — |
| fluoride | | |
| tetramethylammonium | 4.0 | 9.4 |
| hydroxide | | |
| polyethyleneimine* | 0.01 | 0.1 |
| water | 88.99 | 82.45 |
| pH | 5 | 6 |
| Condition of cleaning | | |
| temperature (° C.) | 40 | 50 |
| time (minute) | 3 | 4 |
| Removal of etching residues | fair | fair |
| Corrosion of copper | excellent | excellent |

*Polyethyleneimine having an average molecular weight of 600

As shown in Tables 5 and 6, in Examples 10 to 18 in which the cleaning solution and the cleaning process of the present invention were applied, no corrosion of copper was found, and the removal of the etching residues was excellent. As shown in Example 12, no corrosion of copper was found even when the cleaning was conducted at a higher temperature for a longer time than those in Example 11. In contrast, when polyethyleneimine (the corrosion inhibitor) was not added (Comparative Example 9), corrosion of copper was found. In all of other Comparative Examples 8 to 14, the removal of the etching residues was incomplete or the corrosion of copper was found.

### INDUSTRIAL APPLICABILITY

The cleaning solution of the present invention is safe and exhibits little adverse effects on the environment. Since the etching residues on semiconductor substrates can be easily removed in a short time by using the cleaning solution of the present invention, fine working of the semiconductor substrates is made possible entirely without corrosion of the wiring material. Moreover, the use of an organic solvent such as an alcohol as the rinsing liquid is not necessary, and the rinsing can be conducted with water alone. Therefore, the production of circuit wiring with high precision and high quality is made possible.

1. A cleaning solution for semiconductor substrates, which comprises an oxidizing agent, an acid and a fluorine compound, has a pH adjusted in a range of 3 to 10 by addition of a basic compound and has a concentration of water of 80% by weight or greater.

2. A cleaning solution for semiconductor substrates, which comprises an oxidizing agent, an acid, a fluorine compound and a corrosion inhibitor, has a pH adjusted in a range of 3 to 10 by addition of a basic compound and has a concentration of water of 80% by weight or greater.

3. A cleaning solution according to claim 1, wherein a ratio of an amount by weight of the acid to an amount by weight of the oxidizing agent is in a range of 0.1 to 1,000.

4. A cleaning solution according to claim 1, wherein the oxidizing agent is hydrogen peroxide.

5. A cleaning solution according to claim 1, wherein the oxidizing agent is nitric acid.

6. A cleaning solution according to claim 1, wherein the acid is an inorganic acid.

7. A cleaning solution according to claim 6, wherein the inorganic acid is at least one acid selected from a group consisting of boric acid, sulfamic acid, phosphoric acid and carbonic acid.

8. A cleaning solution according to claim 6, wherein the inorganic acid is sulfuric acid.

9. A cleaning solution according to claim 1, wherein the acid is an organic acid.

10. A cleaning solution according to claim 9, wherein the organic acid is at least one acid selected from a group consisting of oxalic acid, citric acid, propionic acid and acetic acid.

11. A cleaning solution according to claim 10, wherein the fluorine compound is ammonium fluoride or tetramethylammonium fluoride.

12. A cleaning solution according to claim 1, wherein the basic compound is a strong base having no metal ions.

13. A cleaning solution according to claim 12, wherein the strong base having no metal ions is tetramethylammonium hydroxide or trimethylhydroxyethylammonium hydroxide.

14. A cleaning solution according to claim 2, wherein the corrosion inhibitor is polyethyleneimine.

15. A cleaning solution according to claim 1, which further comprises a surfactant.

16. A cleaning solution according to claim 15, wherein the surfactant is an anionic surfactant.

17. A cleaning solution according to claim 16, wherein the anionic surfactant is a phosphoric ester of a polyoxyethylenealkyl ether or a phosphoric ester of a polyoxyethylenealkyl aryl ether.

18. A cleaning solution according to claim 1, adapted for cleaning semiconductor substrates having metal wiring which comprises copper alone or a laminate structure of copper and a barrier metal.

19. A process for cleaning semiconductor substrates having metal wiring, which comprises cleaning with a cleaning solution described in claim 1.

20. A process according to claim 19, wherein said metal wiring comprises copper alone or a laminate structure of copper and a barrier metal.

21. A cleaning solution according to claim 2, wherein a ratio of an amount by weight of the acid to an amount by weight of the oxidizing agent is in a range of 0.1 to 1,000.

22. A cleaning solution according to claim 2, wherein the oxidizing agent is hydrogen peroxide.

23. A cleaning solution according to claim 2, wherein the oxidizing agent is nitric acid.

24. A cleaning solution according to claim 2, wherein the acid is an inorganic acid.

25. A cleaning solution according to claim 24, wherein the inorganic acid is at least one acid selected from a group consisting of boric acid, sulfamic acid, phosphoric acid and carbonic acid.

26. A cleaning solution according to claim 24, wherein the inorganic acid is sulfuric acid.

27. A cleaning solution according to claim 2, wherein the acid is an organic acid.

28. A cleaning solution according to claim 27, wherein the organic acid is at least one acid selected from a group consisting of oxalic acid, citric acid, propionic acid and acetic acid.

29. A cleaning solution according to claim 28, wherein the fluorine compound is ammonium fluoride or tetramethylammonium fluoride.

30. A cleaning solution according to claim 2, wherein the fluorine compound is ammonium fluoride or tetramethylammonium fluoride.

31. A cleaning solution according to claim 1, wherein the fluorine compound is ammonium fluoride or tetramethylammonium fluoride.

32. A cleaning solution according to claim 2, wherein the basic compound is a strong base having no metal ions.

33. A cleaning solution according to claim 32, wherein the strong base having no metal ions is tetramethylammonium hydroxide or trimethylhydroxyethylammonium hydroxide.

34. A cleaning solution according to claim 2, which further comprises a surfactant.

35. A cleaning solution according to claim 34, wherein the surfactant is an anionic surfactant.

36. A cleaning solution according to claim 35, wherein the anionic surfactant is a phosphoric ester of a polyoxyethylenealkyl ether or a phosphoric ester of a polyoxyethylenealkyl aryl ether.

37. A cleaning solution according to claim 2, adapted for cleaning semiconductor substrates having metal wiring which comprises copper alone or a laminate structure of copper and a barrier metal.

38. A cleaning solution according to claim 15, adapted for cleaning semiconductor substrates having metal wiring which comprises copper alone or a laminate structure of copper and a barrier metal.

39. A process for cleaning semiconductor substrates having metal wiring, which comprises cleaning with a cleaning solution described in claim 2.

40. A process for cleaning semiconductor substrates having metal wiring, which comprises cleaning with a cleaning solution described in claim 15.
